(19) United States
(12) Patent Application Publication
(10) Pub. No.: US 2009/0178753 A1
(43) Pub. Date: Jul. 16, 2009

(54) PROCESS FOR KEYPAD PANEL HAVING ARRAYS OF MICROPORES

(76) Inventors: Chang-Li LIU, Taoyuan (TW); Che-Tung Wu, Taoyuan (TW)

Correspondence Address: HDLS Patent & Trademark Services, P.O. BOX 220746, CHANTILLY, VA, 20153-0746, US

(21) Appl. No.: 12/036,535

(22) Filed: Feb. 25, 2008

(30) Foreign Application Priority Data
Jan. 10, 2008 (TW) 097101063

(51) Int. Cl. B32B 38/04

(52) U.S. Cl. 156/77

(57) ABSTRACT

A process for a keypad panel having arrays of micropores includes the steps as follows. First, a plastic thin plate is prepared. A shielding layer is formed on one surface of the plastic thin plate. A plurality of micropores is formed on the shielding layer via an etching process. The micropores are arranged to form patterns for pressing. Then, the plastic thin plate is cut to form a keypad panel of a predetermined shape. A backlight module is adhered on one surface of the shielding layer. A telecommunication module is arranged on one surface of the backlight module. When a set of light-emitting units are lighted up, the light enters one end of a light-guiding plate. The light is reflected by light-guiding microstructures onto the corresponding key, so that the user can see the position of each key clearly.

### RELATED APPLICATIONS

U.S. patent applications Ser. No. 12/014,857 filed on Jan. 16, 2008, Ser. No. 11/957,771 filed on Dec. 17, 2007 are submitted as related applications.

### BACKGROUND OF THE INVENTION

1. Field of the Invention

The present invention relates to a keypad panel, and in particular to a method for manufacturing a keypad panel.

2. Description of Prior Art

With the continuous progress of technologies, many electronic devices are manufactured to a more compact extent so as to reduce the size and weight of the electronic device. Thus, it is convenient for a user to carry or store such a compact electronic device. In order to reduce the size and weight of the electronic device, not only the volume of circuit boards and electronic components within the electronic device is reduced, but also the volume of the housing and the operating keypad panel of the electronic device should be reduced.

As shown in FIGS. 1(a) and 1(b), US Patent publication No. 2007/0205986A1 discloses a current keypad panel. The disclosed metallic keypad panel 10a has an elastic layer 1a. One surface of the elastic layer 1a has thereon a plurality of protrusions 11a. The other surface of the elastic layer 1a is arranged with a plurality of metallic keys 2a to correspond to the protrusions 11a. The metallic key 2a has a hollowed portion 21a with a corresponding pattern. A light-transmitting resin layer 22a is filled in the hollowed portion 21a. When the metallic keypad panel 10a is disposed in a base 20a of an electronic device, the metallic keypad panel 10a is located on a telecommunication module 30a. The telecommunication module 30a has a printed circuit board 31a. The circuit board 31a has a plurality of immovable contacting points 32a. A metallic sheet 33a is disposed on the circuit board 31a. The metallic sheet 33a has thereon a plurality of convex metal domes 331a. Each metal dome 331a corresponds to each contacting point 32a, and the other surface of each metal dome 331a corresponds to each protrusion 11a. When the metallic key 2a is pressed, the protrusion 11a is caused to press the surface of the metal dome 331a, so that the metal dome 331a is deformed and brought into contact with the contacting point 32a, thereby generating an electronic signal output. Further, when a backlight source is lighted up, the light of the backlight source can pass through the resin layer 22a of the metallic key 2a, so that the user can see the position of each key clearly. Although the above-mentioned metallic keypad panel 10a has been manufactured to a compact extent and can be mounted in a small-volume electronic device, during the manufacturing process, it is necessary to fill the individual hollowed portions 21a on the metallic key 2a with the resin layer 22a, and each of the metallic keys 2a has to be adhered onto one surface of the elastic layer 1a accurately. As a result, the manufacturing process takes a lot of time and labors and is not simple. After the metallic keypad panel 10a is combined with the base 20a, a gap is formed between the periphery of the metallic key 2a and the base 20a, and the gap may be filled by external dusts or penetrated by moisture easily. As a result, the metallic key cannot be pressed smoothly or an internal short circuit may occur. Further, when the backlight source of the keypad panel 10a is lighted up, the hollowed portion 21a of the key 2a merely displays single luster. Therefore, the external appearance and the overall visual effect of the metallic keypad panel are dull.

### SUMMARY OF THE INVENTION

In view of the above drawbacks, the present invention is to provide a keypad panel that is simple in structure and can be manufactured easily. Therefore, the pattern on the keypad panel can be displayed more clearly. Also, the keypad panel can be protected against the accumulation of dusts and the penetration of moisture.

The present invention is to provide a process for a keypad panel having arrays of micropores. First, a plastic thin plate is prepared. A shielding layer is formed on one surface of the plastic thin plate. A plurality of micropores are formed on the shielding layer via an etching process. The micropores are arranged to form patterns for pressing. Then, the plastic thin plate is cut to form a keypad panel of a predetermined shape. A light-guiding plate of a backlight module is adhered on one surface of the shielding layer. The light-guiding plate has a plurality of light-guiding microstructures corresponding to the patterns. A set of light-emitting units are arranged on one end of the light-guiding plate. A sheet-like shielding unit is arranged above the set of light-emitting units and the light-guiding plate. Finally, a telecommunication module is adhered to one surface of the backlight module. The telecommunication module has a flexible printed circuit board. The circuit board is provided thereon with a plurality of contacting points. Each contacting point corresponds to a metal dome. A film layer is arranged on one surface of the circuit board and the metal dome. A protrusion is provided on the protruding surface of the film layer. The protrusion corresponds to the light-guiding microstructures of the light-guiding plate.

### BRIEF DESCRIPTION OF THE DRAWINGS

FIGS. 1(a) and 1(b) are schematic views showing a conventional metallic keypad panel;

FIG. 2 is a flow chart showing the process for a keypad panel of the present invention;

FIGS. 3(a) to 3(i) are schematic views showing the respective structures generated by the process for the keypad panel of the present invention;

FIG. 4(a) is an assembled side view showing the keypad panel, the backlight module and the telecommunication module of the present invention;

FIG. 4(b) is a schematic view showing a pressing action of the keypad panel, the backlight module and the telecommunication module of the present invention;

FIG. 5 is an assembled side view showing the keypad panel, the backlight module and another telecommunication module of the present invention;

FIG. 6 is a schematic view showing the keypad panel of the present invention being used in a mobile phone;

FIG. 7 is a schematic view showing the keypad panel of the present invention being used in a personal digital assistant; and

FIG. 8 is a schematic view showing the keypad panel of the present invention being used in an automobile stereo panel.

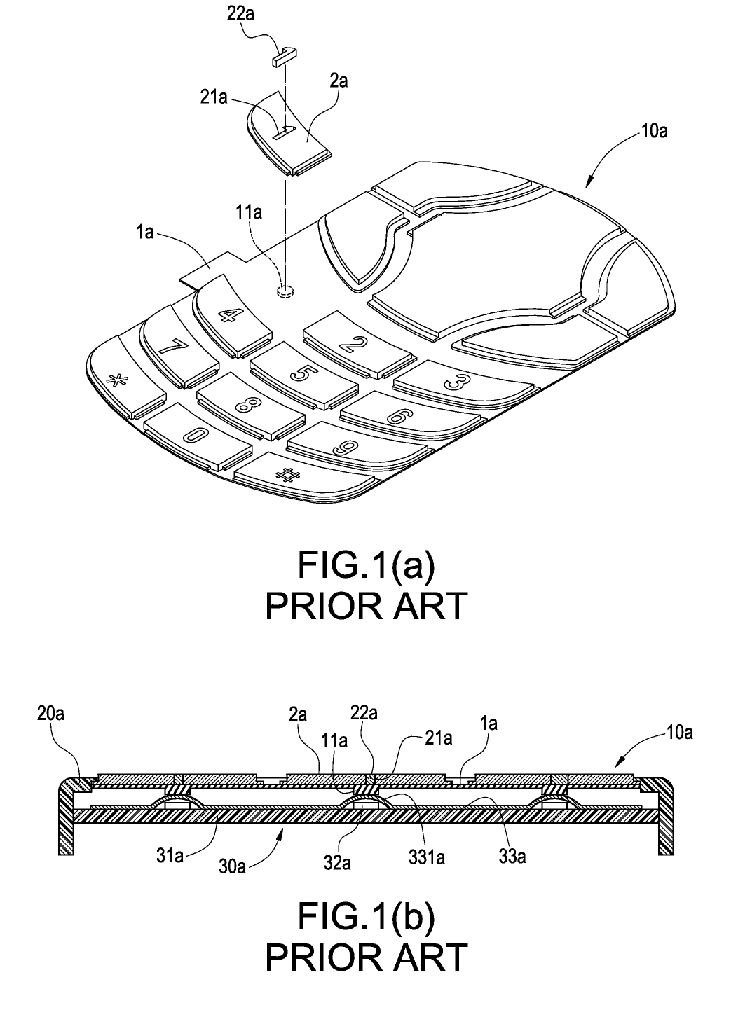

### DETAILED DESCRIPTION OF THE INVENTION

The detailed description and technical contents of the present invention will be explained with reference to the accompanying drawings.

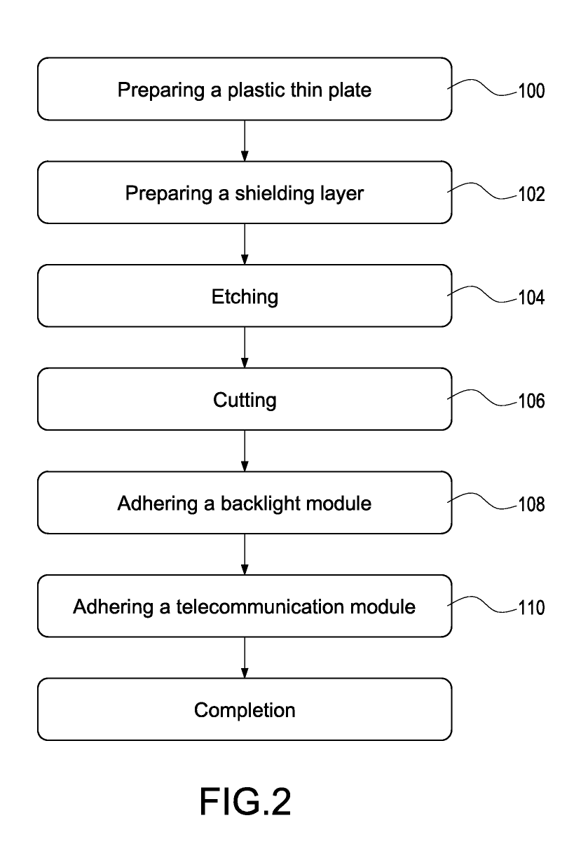

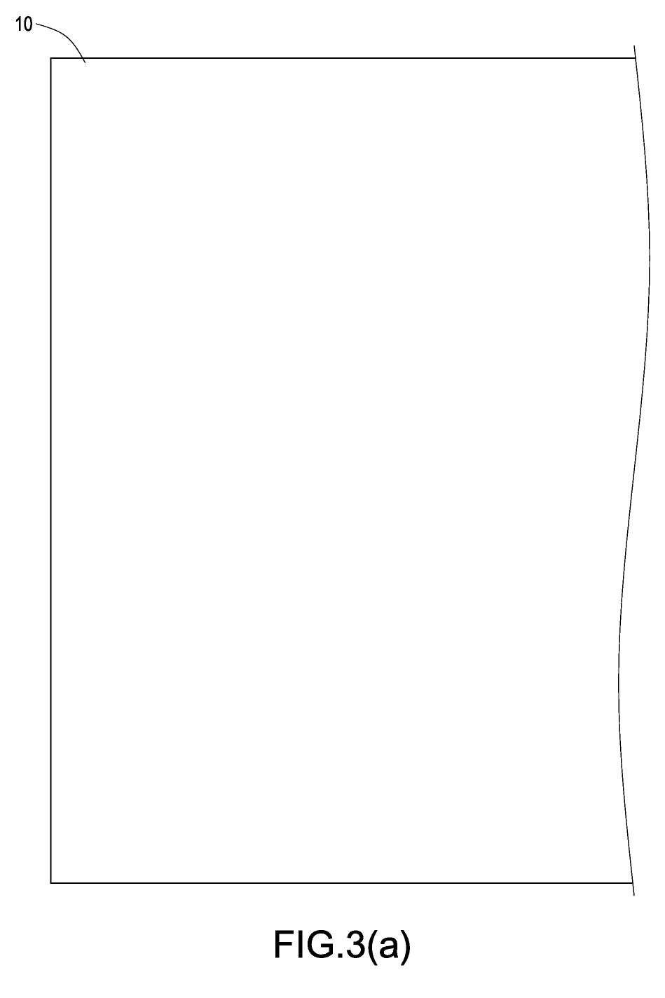

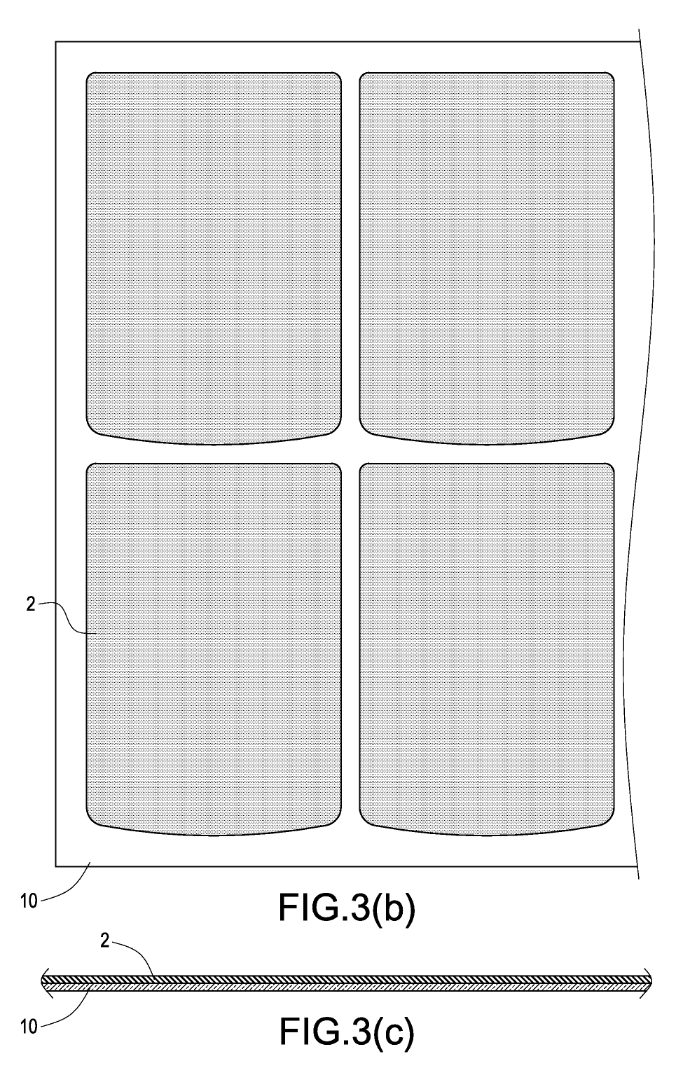

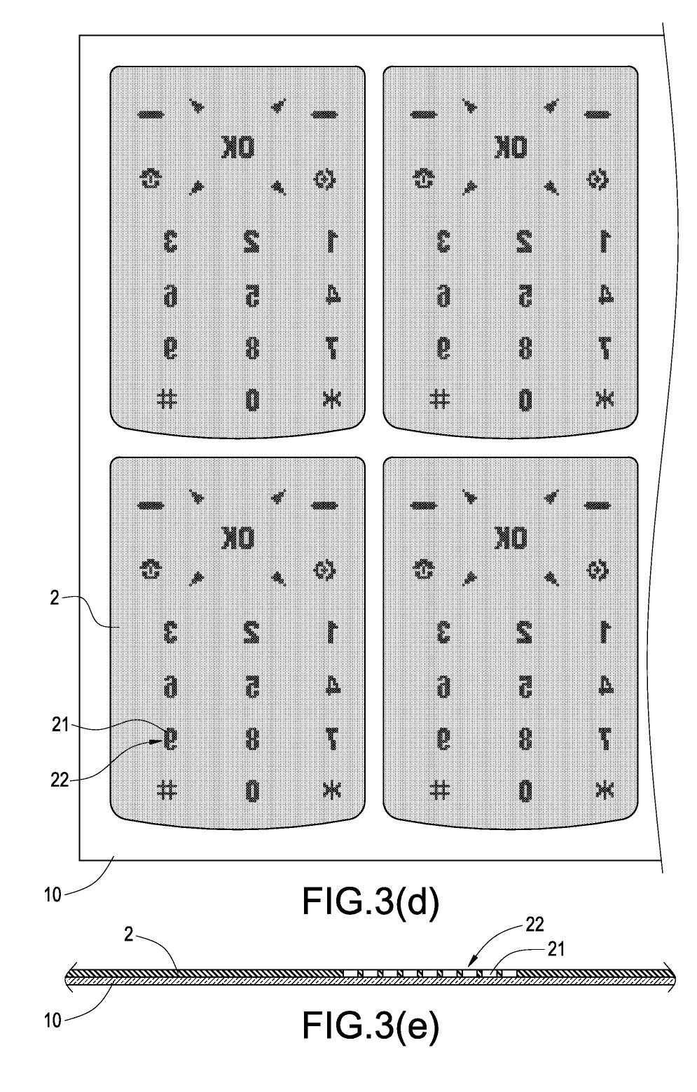

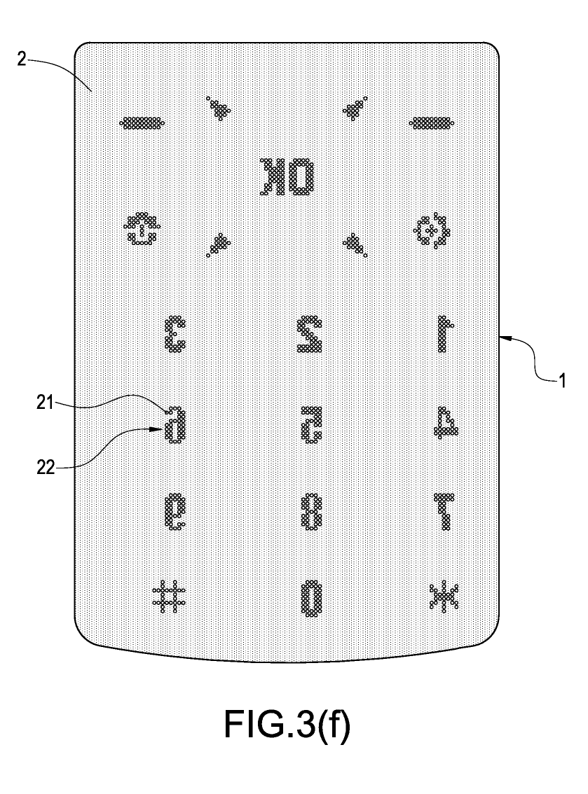

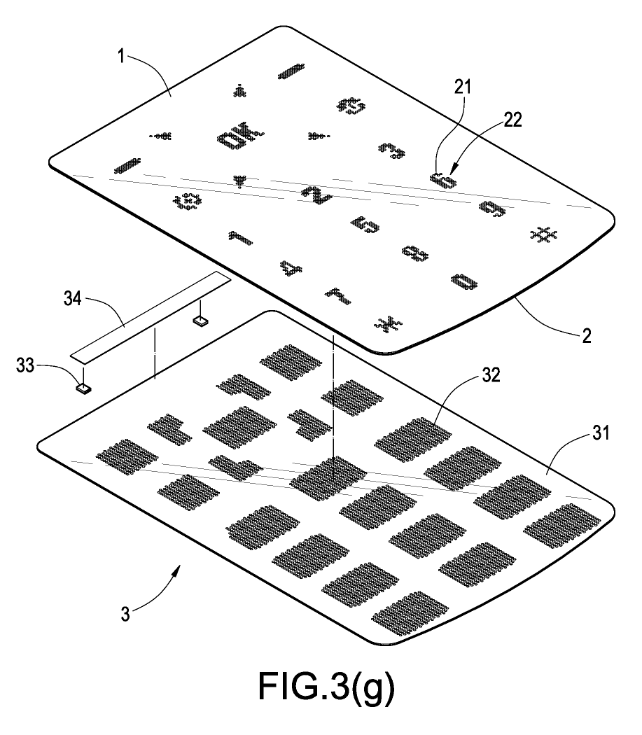

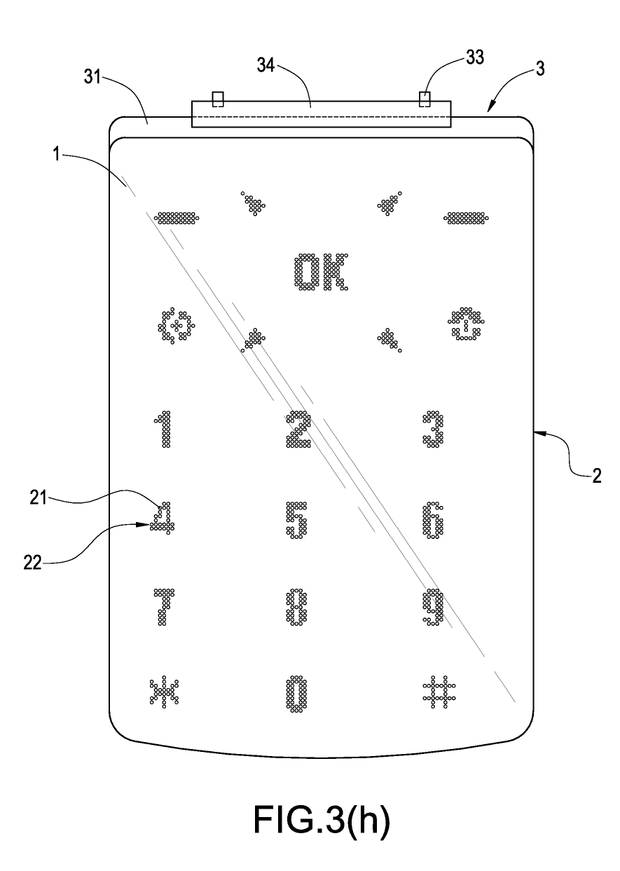

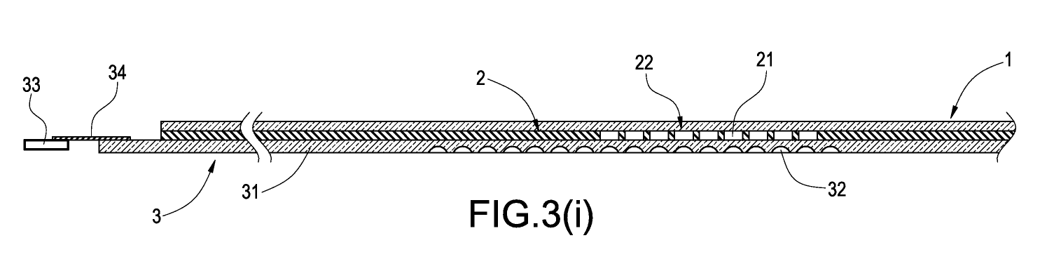

With reference to FIG. 2, it is a flow chart showing the process of the present invention for a keypad panel having arrays of micropores. As shown in this figure, according to the present invention, the process for a keypad panel having arrays of micropores includes the steps as follows. First, in the step 100, a plastic thin plate 10 is prepared as shown in FIG. 3(a). The plastic thin plate 10 is made of a plastic material such as any one of a PC film or TPU film, and can be made transparent, translucent or opaque.

In the step 102, a shielding layer is prepared. The shielding layer 2 is formed on one surface of the plastic thin plate 10 by an ink printing process. Alternatively, any one of Al, Ni, Ti or Ag can be coated on one surface of the plastic thin plate 10 via a sputtering technology so as to form the shielding layer 2 as shown in FIGS. 3(b) and 3(c).

In the step 104, micropores are prepared. The shielding layer 2 formed by the ink printing process are subjected to an etching process by laser light, thereby forming a plurality of micropores 2 on the shielding layer 2. Alternatively, the shielding layer 2 formed of any one of Al, Ni, Ti or Ag is subjected to a chemical etching process to form a plurality of micropores 21. The micropores 21 are arranged to form patterns 22 for pressing. The above-mentioned patterns 22 are any of numerals, characters, specific symbols (“#”, “*”, “.”) and direction symbols, as shown in FIGS. 3(d) and 3(e).

In the step 106, the plastic thin plate 10 is cut to form a keypad panel 1 of a predetermined shape, as shown in FIG. 3(f).

In the step 108, a backlight module 3 is adhered, as shown in FIGS. 3(g) to 3(i). A plate-like light-guiding plate 31 is adhered on one surface of the shielding layer 2. The light-guiding plate 31 can be formed on one surface of the shielding layer 2 via hot pressing or adhering. The light-guiding plate 31 has light-guiding microstructures 32 corresponding to the patterns 22. Further, a set of light-emitting units 33 are arranged on one end of the light-guiding plate 31. A sheet-like shielding unit 34 is arranged above the set of light-emitting units 33 and the light-guiding plate 31. The shielding unit 34 shields the light generated by the set of light-emitting units 33, thereby avoiding the mutual interference of light. The set of light-emitting units 33 are constituted of a plurality of light-emitting diodes of the same or different colors. The above-mentioned light-guiding microstructures 32 are recessed in the light-guiding plate 31, or protrude from one surface of the light-guiding plate 31.

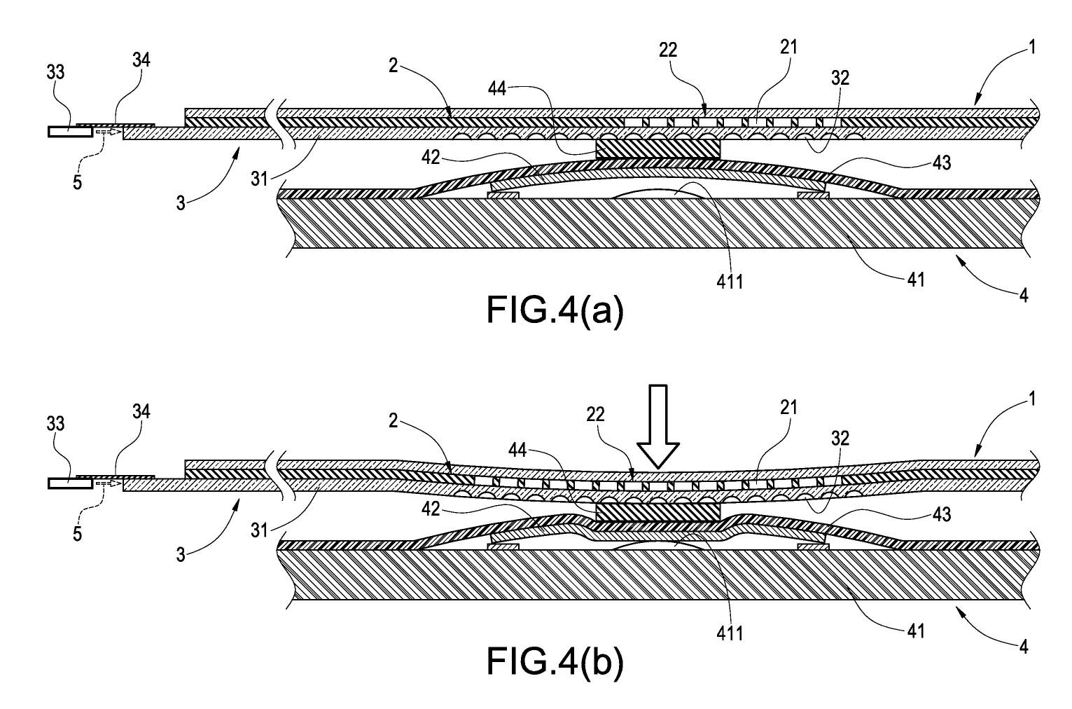

In the step 110, a telecommunication module 4 is adhered, as shown in FIGS. 4(a) and 4(b). The telecommunication module 4 is adhered on one surface of the backlight module 3. The telecommunication module 4 has a flexible printed circuit board (FPCB) 41. The circuit board 41 is provided thereon with a plurality of contacting points 411. Each contacting point 411 corresponds to a metal dome 42. A film layer 43 is disposed on one surface of the circuit board 41 and the metal dome 42. The protruding surface of the film layer 43 is provided with a protrusion 44. The protrusion 44 corresponds to the light-guiding microstructures 32 of the light-guiding plate 31.

Please refer to FIGS. 4(a) and 4(b). FIG. 4(a) is an assembled side view showing the keypad panel, the backlight module and the telecommunication module 4 of the present invention, and FIG. 4(b) is a schematic view showing a pressing action of the present invention. As shown in these figures, under the control of the circuit (not shown) of an associated electronic device, when the set of light-emitting units 33 are lighted up, the light generated by the set of light-emitting units 33 enters the light-guiding plate 31. Then, the light 5 is refracted by the light-guiding microstructures 32 onto the corresponding pattern 22. The light 5 passes through the plurality of micropores 11 to display the pattern 22 on the surface of the keypad panel 1.

When the surface of the keypad panel 1 is pressed by an external force, the keypad panel 1 and the light-guiding plate 31 are deformed to cause the protrusion 44 to press the film layer 43. As a result, the metal dome 42 is deformed and pressed to contact with the contacting point 411, thereby generating a conductive signal output.

When one surface of the keypad panel 1 is not pressed by an external force, due to the elasticity of the keypad panel 1 and the metal dome 42, the keypad panel 1 may rise automatically to its original state.

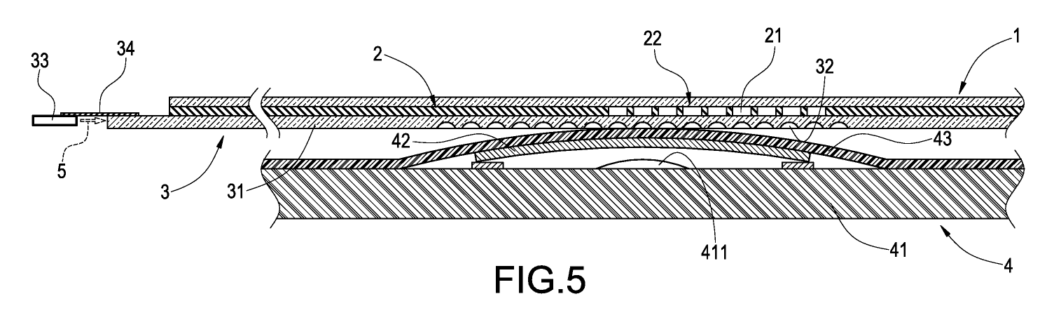

Please refer to FIG. 5, which is an assembled side view showing the keypad panel, the backlight module and another telecommunication module of the present invention. As shown in this figure, another telecommunication module 4 is arranged on one surface of the backlight module. The telecommunication module 4 has a flexible printed circuit board (FPCB) 41. The circuit board 41 is provided thereon with a plurality of contacting points 411. Each contacting point 411 corresponds to a metal dome 42. A film layer 43 is arranged on one surface of the circuit board 41 and the metal dome 42. The metal dome 42 corresponds to the light-guiding microstructures 32 on the light-guiding plate 31.

When the surface of the pattern 22 on the keypad panel 1 is pressed by an external force, the keypad panel 1 and the light-guiding plate 31 are deformed to press the film layer 43. As a result, the metal dome 42 is deformed and pressed to contact with the contacting point 411, thereby generating a conductive signal output.

When one surface of the keypad panel 1 is not pressed by an external force, due to the elasticity of the keypad panel 1 and the metal dome 42, the keypad panel 1 may rise automatically to its original state.

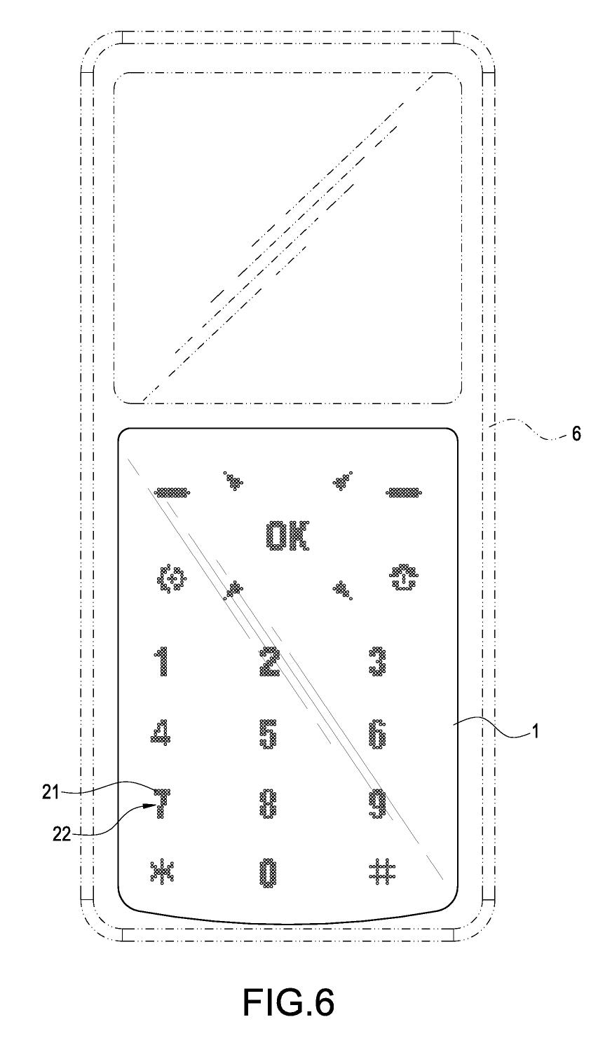

With reference to FIG. 6, it is a schematic view showing the keypad panel of the present invention being used in a mobile phone. As shown in this figure, after the keypad panel 1 of the present invention is manufactured completely, it can be applied to a mobile phone 6. When the light illuminates the keypad panel 1, the keypad panel 1 generates a backlight of a luster, thereby increasing the aesthetic feeling of the mobile phone 6.

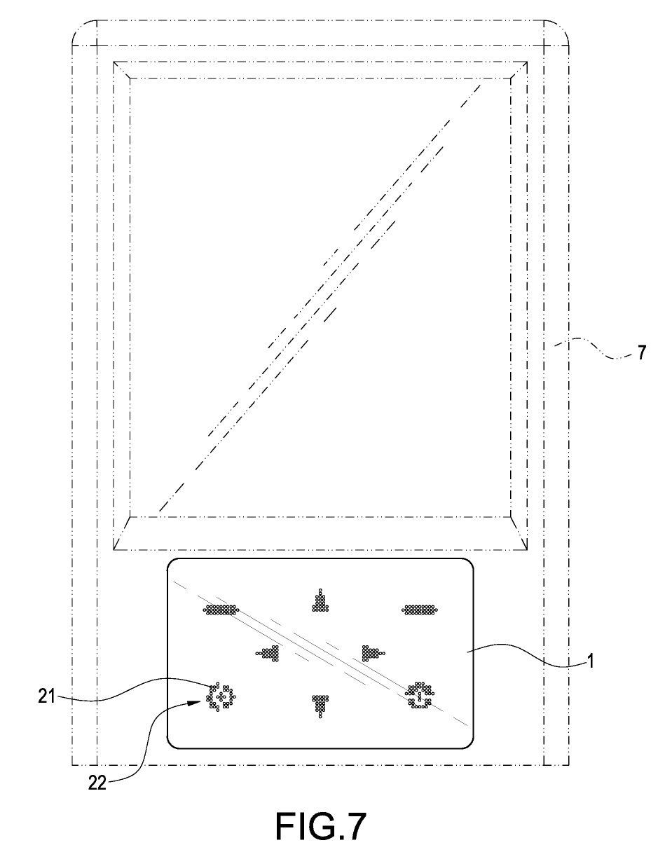

With reference to FIG. 7, it is a schematic view showing the keypad panel of the present invention being used in a personal digital assistant. As shown in this figure, after the keypad panel 1 of the present invention is manufactured completely, in addition to the mobile phone 6, it can be applied to a personal digital assistant (PDA) 7. When the light illuminates the keypad panel 1, it generates a backlight of a luster, thereby increasing the aesthetic feeling of the personal digital assistant (PDA) 7.

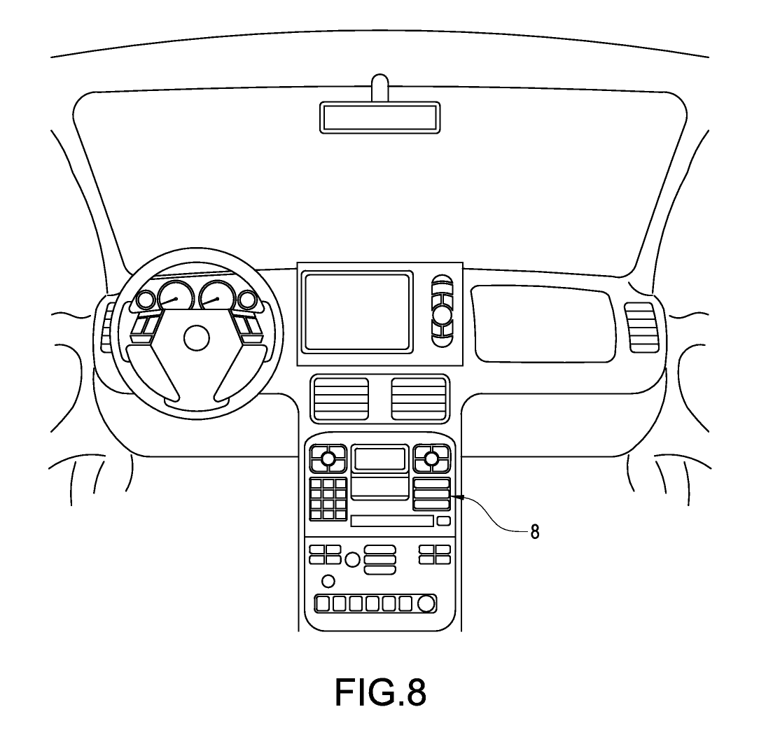

With reference to FIG. 8, it is a schematic view showing the keypad panel of the present invention being used in an automobile stereo panel. As shown in this figure, after the keypad panel 1 of the present invention is manufactured completely, in addition to the mobile phone 6 and the personal digital assistant (PDA) 7, it can be mounted in an automobile stereo panel 8, thereby controlling the operations of an air conditioning system, audio-video system and satellite navigation system.

Although the present invention has been described with reference to the foregoing preferred embodiments, it will be understood that the invention is not limited to the details thereof Various equivalent variations and modifications can still occur to those skilled in this art in view of the teachings of the present invention. Thus, all such variations and equivalent modifications are also embraced within the scope of the invention as defined in the appended claims.

What is claimed is:

1. A process for a keypad panel having arrays of micropores, the keypad panel being disposed on a surface of an electronic device, the process comprising the steps of:
(a) preparing a plastic thin plate;
(b) forming a shielding layer on one surface of the plastic thin plate;
(c) forming a plurality of micropores on the shielding layer, and arranging the plurality of micropores to form patterns;
(d) cutting the plastic thin plate to form a keypad panel of a predetermined shape; and
(e) adhering a light-guiding plate of a backlight module on one surface of the shielding layer, the light-guiding plate being formed on one surface of the shielding layer via hot pressing or adhering, and the light-guiding plate having light-guiding microstructures corresponding to the patterns.

2. The process according to claim 1, wherein the plastic thin plate prepared in the step (a) is made of a plastic material of any one of a PC film or TPU film.

3. The process according to claim 1, wherein the shielding layer formed in the step (b) is formed on one surface of the plastic thin plate via inks.

4. The process according to claim 1, wherein the shielding layer formed in the step (b) is formed on one surface of the plastic thin plate via a material selected from any one of Al, Ni, Ti or Ag.

5. The process according to claim 1, wherein the pattern formed in the step (c) comprises any one of numerals, characters, special symbols (“#”, “*”, “.”) and direction symbols.

6. The process according to claim 1, wherein the light-guiding plate mentioned in the step (d) is formed on one surface of the shielding layer via hot pressing or adhering.

7. The process according to claim 1, wherein one end of the light-guiding plate mentioned in the step (d) is provided with a set of light-emitting units, a sheet-like shielding unit is arranged above the set of light-emitting units and the light-guiding plate.

8. The process according to claim 7, wherein the set of light-emitting units are constituted of a plurality of light-emitting diodes having the same or different colors.

9. The process according to claim 7, wherein the light-guiding microstructures are recessed in or protrude from one surface of the light-guiding plate.

10. A process for a keypad panel having arrays of micropores, the keypad panel being disposed on a surface of an electronic device, the process comprising the steps of:
(a) preparing a plastic thin plate;
(b) forming a shielding layer on one surface of the plastic thin plate;
(c) forming a plurality of micropores on the shielding layer, and arranging the plurality of micropores to form patterns;
(d) cutting the plastic thin plate to form a keypad panel of a predetermined shape;
(e) adhering a light-guiding plate of a backlight module on one surface of the shielding layer, the light-guiding plate being formed on one surface of the shielding layer via hot pressing or adhering, and the light-guiding plate having light-guiding microstructures corresponding to the patterns; and
(f) arranging a telecommunication module on one surface of the backlight module.

11. The process according to claim 10, wherein the plastic thin plate prepared in the step (a) is made of a plastic material of any one of a PC film or TPU film.

12. The process according to claim 10, wherein the shielding layer formed in the step (b) is formed on one surface of the plastic thin plate via inks.

13. The process according to claim 10, wherein the shielding layer formed in the step (b) is formed on one surface of the plastic thin plate via a material selected from any one of Al, Ni, Ti or Ag.

14. The process according to claim 10, wherein the pattern formed in the step (c) comprises any one of numerals, characters, special symbols (“#”, “*”, “.”) and direction symbols.

15. The process according to claim 10, wherein the light-guiding plate mentioned in the step (d) is formed on one surface of the shielding layer via hot pressing or adhering.

16. The process according to claim 10, wherein one end of the light-guiding plate mentioned in the step (d) is provided with a set of light-emitting units, a sheet-like shielding unit is arranged above the set of light-emitting units and the light-guiding plate.

17. The process according to claim 16, wherein the set of light-emitting units are constituted of a plurality of light-emitting diodes having the same or different colors.

18. The process according to claim 16, wherein the light-guiding microstructures are recessed in or protrude from one surface of the light-guiding plate.

19. The process according to claim 10, wherein the telecommunication module mentioned in the step (f) has a flexible printed circuit board, the circuit board has thereon a plurality of contacting points, each contacting point corresponds to a metal dome, a film layer is arranged on one side surface of the circuit board and the metal dome, a protrusion is provided on the protruding surface of the film layer, and the protrusion corresponds to the light-guiding microstructures of the light-guiding plate.

20. The process according to claim 10, wherein the telecommunication module mentioned in the step (f) has a flexible printed circuit board, the circuit board has thereon a plurality of contacting points, each contacting point corresponds to a metal dome, a film layer is arranged on one surface of the circuit board and the metal dome.
